(19) United States
(12) Patent Application Publication
(10) Pub. No.: US 2012/0246630 A1
(43) Pub. Date: Sep. 27, 2012

(54) System and Method for Automating Installation and Updating of Third Party Software

(75) Inventors: Sascha Kuzins, San Francisco, CA (US); Patrick Swieskowski, New York, NY (US)

(73) Assignee: Secure By Design, San Francisco, CA (US)

(21) Appl. No.: 13/428,789

(22) Filed: Mar. 23, 2012

Related U.S. Application Data
(60) Provisional application No. 61/466,594, filed on Mar. 23, 2011.

(51) Int. Cl. G06F 9/445

(52) U.S. Cl. 717/169

(57) ABSTRACT

A software application installation system facilitates automatic installation and/or updating of software applications without requiring a user to have any specific knowledge of the configuration of the computer system upon which the software application is to be installed and/or updated. The software applications to be installed may be supplied by third party providers. The installation is based on automatically derived knowledge of the computer system on which the software applications are to be installed. The software applications may be installed automatically using a standardized user interface (UI), and/or without requiring substantial user input.

### RELATED APPLICATIONS

This application claims priority to and benefit of U.S. Provisional Patent Application Ser. No. 61/466,594, filed on Mar. 23, 2011, the entire content of which is hereby incorporated by reference in its entirety.

### FIELD OF THE INVENTION

The invention relates generally to the field of computer software, and specifically, to automating software installation and updates.

### BACKGROUND

In today's computing landscape, computer users often download software applications over the Internet. In some instances, in order to use a downloaded software application, a user manually performs several steps to make the software available for use on a computer system, in a process commonly referred to as software installation. For some operating systems, the installation steps differ based on the applications being installed, and as such, the user may be required to know the different steps to manually install the software.

Another complication may arise when different types, versions, and languages (e.g., English, German, etc.) of operating systems are involved. For some software applications, a user must download a specific version of the software application that matches the type and version of the operating system on the user's computer. The user may also need to download the particular file version having the correct translation/localization of the software application to be installed on the user's computer system. Thus, the user may need to have knowledge of the specific configuration of his/her computer system, without which, the software application may not be installed correctly. As such, this manual selection and installation process includes a significant risk of error.

One common way to avoid some of the problems described above is to use a software installation program. Such a program typically executes the required installation steps and modifies the contents of a persistent storage (e.g., a hard disk) of the computer system, thereby changing the state of the computer system, so as to make the software application available for use on the computer system. Even with a software installation program, however, software installation can be problematic.

Just as one example, software applications may require some collection of installation programs that the user must download from separate software vendors or sites. In addition, several installation programs prompt the user to select options during installation. These selections often relate to the language (e.g., English, German, etc.) of the software application and the location in the file system where the software application is to be installed. This interaction with the installation program can be tedious and error prone, especially for novice users. Further, it may be difficult for IT professionals to automate the installation of software applications on a number of computers if each installation requires substantial user input or has different settings and/or states.

Some versions of the Linux operating system include the Advanced Packaging Tool (“APT”), a software package that can download and install Linux software applications automatically. The APT, however, is not compatible with other operating systems, and such standardized packing formats are not known to exist for other operating systems. The APT also does not install applications that are not provided in a standardized pre-defined package format at a central depository.

The Windows Installer (commonly known as MSI) offers a unified interface to software installation on computers using the Windows operating system. The MSI also has several limitations, however. Specifically, MSI does not automatically download third-party (non-Microsoft) software. Users must manually acquire the files that make up the software package, for example by going to a software application vendor's web site and downloading the files, ordering a CD via mail, etc. The MSI also does not automate the selection of the right version of a software application according to the operating system version and/or language. For many software applications the MSI is simply not available. Moreover, during installation the MSI presents different user interfaces according to the software application being installed and the associated setup program supplied by the software vendor, and thus, requires substantial user interaction.

In general, the vendor of a software application to be installed supplies an MSI package that contains MSI instructions, files, and/or installation programs. The MSI instructions are executed by the MSI service on the user's computer. The instructions can cause the MSI to perform operations such as copying files to certain destinations and/or executing installation programs from the MSI package. Some MSI packages may not contain installation programs and only instructions for copying files, whereas other MSI packages may only contain an installation program that is executed by the MSI service. Thus, the MSI packages and service may not provide automatic installation of a software application.

Therefore, there is a need for improved systems and methods for installing software applications on a computer system.

### SUMMARY OF THE INVENTION

In various embodiments, systems and methods according to the present invention facilitate automatic installation and/or updating of software applications without requiring a user to have any specific knowledge of the configuration of the computer system upon which the software application is to be installed and/or updated. This is achieved, in part, by providing a unified software-installation process that automatically manages the identification, selection and receipt of files associated with a software application to be installed.

The files are selected based on automatically derived knowledge of the computer system on which the software application is to be installed. This knowledge may include type, version, and language of the operating system, version of the software application, if installed previously, versions of any other software application installed on the user's computer, etc. The received files may be supplied by one or more third-party providers of software applications. Upon receipt, the files may be installed automatically using a standardized user interface (UI). The files may also be installed without requiring substantial user input by pre-analyzing the input sought from the user during installation and by automatically supplying pre-determined input. Such automatic installation without significant user interaction can be highly beneficial if software applications are to be installed on a large number of computers.

In various embodiments, a software application installation system provides a unified interface for downloading and installing software applications. An exemplary system includes: (1) a web-server accessible via a website that lists software applications available for installation/update using the installation system; (2) a bootstrap software component (also called a “stub”) that is downloaded from the web-server, and tagged with a key that represents selected software applications; (3) a main software component (also called a “main program”) downloaded by the stub or in response to the key that facilitates automation of the software installation; (4) and a hosted web service that provides instructions to the main program, and optionally to the stub, for installing the software application.

The separation of the application into a stub and main program components enables an end user to retrieve the current, published version of the main program. The main program is a generic component which interprets instructions on how to install the specified software products. Users may store the keyed stub on storage media (hard disk of the user's computer, USB memory stick, flash memory or a SIM card in a mobile device, etc.) and may execute the stub when they wish to perform installations and/or updates. The stub fetches the latest version of the main component from the web server, ensuring that the user has access to the latest functionality and improvements made to the main program. As an optimization, the stub may also cache the main program locally, i.e., on the user's computer. In this case, the stub may check if the cached main program has changed based on a time stamp or checksum and may download the latest version of the main program only if there has been a change and the cached version is out of date.

The main software component utilizes the installation instructions to determine the files to be downloaded, determine the Uniform Resources Locators (“URL”) to be used to download the files, download the files, and perform steps to install the software applications using the downloaded files, among other functions. The automatic installation process includes creating processes based on the downloaded files, monitoring the state of the processes, sending messages to the processes based on their state, copying and manipulating files and other system state (such as registry keys), and hiding visible elements of the processes from the screen. The main software component may also make default choices on behalf of the user to reduce user interaction with the third-party set-up programs. At the end of the installation process, the installation system may generate a status report with the results of the installations. The report may be presented to the user to confirm installation, to providers of the application(s) being installed for quality assurance or license tracking purposes, and/or IT staff to ensure security compliance among others.

Accordingly, in one aspect, a method for automatically installing a software application or components thereof on a computer includes sending from a computer an identification of a first software application component to be installed on the computer, and receiving a bootstrap component at the computer. The bootstrap component includes a key corresponding to the first software application. The method also includes receiving (i) a main program at the direction of the bootstrap component, (ii) software installation instructions for installing the software application component on the computer, and (iii) the first software application component. The method further includes identifying by the main program a version of the first software application component if the first software application component is installed on the computer, and installing the first software application component on the computer. The receiving of the first software application component and/or installation thereof is done at the direction of the main program operating based on the software installation instructions and/or the identified version.

In some embodiments, the software installation instructions include a Uniform Resource Locator (URL). The URL may be a URL expression including instructions to retrieve data from other URLs. The URL expression may also include primitives to send HTTP requests and manipulate a response. In some embodiments, the method includes executing instructions including primitives to access and manipulate data of the version of the software application component installed on the computer.

In some embodiments, the method includes traversing each of several programs. For each traversed program, configuration information is retrieved from a web service, a URL expression is retrieved from the configuration information, and a program corresponding to the URL expression is retrieved. The method may also include storing the program in temporary file. The method may include creating a copy of the main program, and embedding offline installation instructions and the temporary file in the copy of the main program.

In some embodiments, the installation instructions may include several possible configurations for the first software application component, and the method may include selecting one of the several configurations based on an algorithm executed by the main program. The algorithm may select one of the several configurations based on an operating system version, operating system language, machine processor architecture, service packs (a Windows feature for major OS updates), command line parameters or some combination thereof.

In some embodiments, the method includes creating a tree representation of user interface elements. The method may also include identifying erroneous user interface states by matching user interface states associated with the first software application component with the tree representation of user interface elements. The identified erroneous user interface states may be sent, via a network, to a server for inspection.

In another aspect, a method for providing installation software to a computer includes receiving at a computer server an identification of a first software application component to be installed on a client computer. The computer server sends a bootstrap component including a key corresponding to the first software application, a main program, software installation instructions for installing the software application component on the client computer, and the first software application component, to the client computer. The main program is configured to identify a version of the first software application component, if the first software application component is installed on the client computer.

In another aspect, a system for installing software on a computer includes one or more client computers, and one or more computer servers. The computer servers are configured to perform the operations of receiving an identification of a first software application component to be installed on the one or more client computers, and sending a bootstrap component including a key corresponding to the first software application and a main program to the one or more client computers. The computer servers are also configured to send software installation instructions for installing the software application component on the one or more client computers, and the first software application component. The main program is configured to identify a version of the first software application component, if the first software application component is installed on the one or more client computers.

Other aspects and advantages of the invention will become apparent from the following drawings, detailed description, and claims, all of which illustrate the principles of the invention, by way of example only.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention.

FIG. 1 schematically depicts an environment in which a software application installation system according to an embodiment may be operated; and

FIG. 2 illustrates exemplary operation of a software application installation system according to one embodiment.

### DETAILED DESCRIPTION

The following description provides exemplary embodiments of methods and systems consistent with the present invention, which should not be interpreted to limit the scope one of ordinary skill in the art would give to the invention.

As used herein, references to a “device,” “devices,” “machine,” and “machines” may include, without limitation, a general purpose computer including a processing unit, a system memory, and a system bus that couples various system components including the system memory and the processing unit. The general purpose computer may employ the processing unit to execute computer-executable program modules stored on one or more computer readable media forming the system memory. The computer may be a desktop computer used for home or office use, a laptop, notebook or pad computing device, a mobile phone (e.g., an iOS, Andriod or Blackberry-powered device), gaming device (such as a Nintendo Wii or DS, Microsoft XBOX, or Sony PS device) or a set-top box used for distribution and viewing of subscription content. The program modules may include routines, programs, objects, components, data structures, etc., that perform particular tasks or implement particular abstract data types.

As used herein, references to “a module” and “modules”, “function”, “expression,” and “algorithm” mean, but are not limited to, a software or hardware component which performs certain tasks. A module may advantageously be configured to reside on an addressable storage medium and be configured to execute on one or more processors. A module may be fully or partially implemented with a general purpose integrated circuit (IC), co-processor, FPGA, or ASIC. Thus, a module may include, by way of example, components, such as software components, object-oriented software components, class libraries, class components and task components, processes, functions, attributes, procedures, subroutines, segments of program code, drivers, firmware, microcode, circuitry, data, databases, data structures, tables, arrays, and variables. The functionality provided for in the components and modules may be combined into fewer components and modules or further separated into additional components and modules. Additionally, the components and modules may advantageously be implemented on many different platforms, including computers, computer servers, data communications infrastructure equipment such as application-enabled switches or routers, or telecommunications infrastructure equipment, such as public or private telephone switches or private branch exchanges (PBX). In any of these cases, implementation may be achieved either by writing applications that are native to the chosen platform, or by interfacing the platform to one or more external application engines.

In addition, various networks may be employed in accordance with embodiments of the invention, including a wired or wireless local area network (LAN) or wide area network (WAN), a wireless personal area network (PAN), cellular networks (e.g., 3G and 4G) and other types of networks. When used in a LAN networking environment, computers may be connected to the LAN through a network interface or adapter. When used in a WAN networking environment, computers typically include a modem or other communication mechanism. Modems may be internal or external, and may be connected to the system bus via a user-input interface, or other appropriate mechanism. Computers may be connected over the Internet, an Intranet, an Extranet, an Ethernet, or any other network that facilitates communications. Any number of transport protocols may be utilized, including, without limitation, User Datagram Protocol (UDP), Transmission Control Protocol (TCP), Venturi Transport Protocol (VTP), Datagram Congestion Control Protocol (DCCP), Fibre Channel Protocol (FCP), Stream Control Transmission Protocol (SCTP), Reliable User Datagram Protocol (RUDP), and Resource ReSerVation Protocol (RSVP). For wireless communications, communications protocols may include Bluetooth, Zigbee, IrDa or other suitable protocol. Furthermore, components of the systems described herein may communicate through a combination of wired or wireless paths.

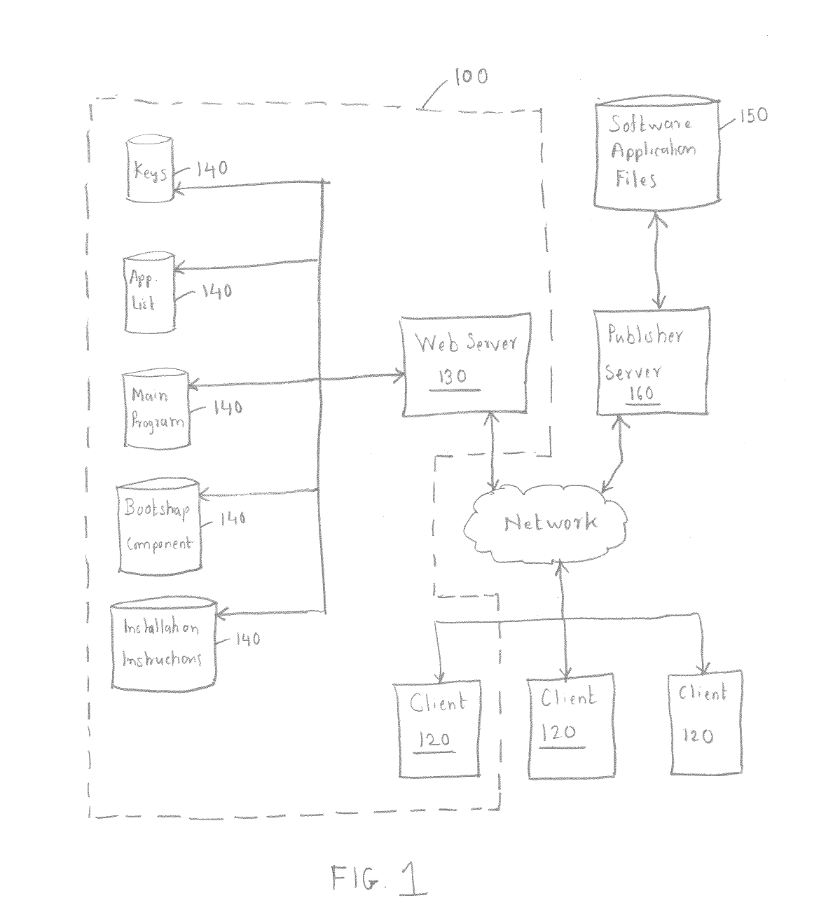

FIG. 1 illustrates an exemplary Installation System 100. The Installation System 100 includes Clients 120, a Web-Server 130, Storage Devices 140, and Application Storage Devices 150. The Clients 120 are computers on which a software application is to be installed, and may include traditional personal computers, mobile devices (e.g., cellular phones, smart phones and PDAs) as well as notebooks, tablet computers, etc. The Web-Server 130 is accessible to the Clients 120 via a web-site. The Web-Server 130 may access the Storage Devices 140, which may be local to the Web-Server 130 and/or may be located remotely. The Storage Devices 140 store (e.g., in one or more databases) one or more bootstrap components (i.e., stubs), one or more main programs, installation instructions that may be used by the main programs, lists of software applications that may be installed and/or updated using the installation system 100, and application set keys representing a set of applications.

The Storage Device 150 includes the installation file or package for installing a software application. The Storage Device 150 is accessible by the Publisher Server 160, which can be a third-party publisher of the application to be installed on the Clients 120. The Storage Device 150 may be local to the Publisher Server 160 and/or may be located remotely. The Clients 120 may communicate with the Web-Server 130 and the Publisher Server 160 via a network (e.g., the Internet).

Although FIG. 1 depicts one Web-Server 130, other embodiments may use more than one Web-Server, for example, one Web-Server for each service provided by the Installation System 100. Similarly, while FIG. 1 depicts one Storage Device 150 and one Publisher Server 160, in other embodiments, the Clients 120 may communicate with many storage devices and/or publisher servers across a network (e.g., the Internet) to retrieve software applications for installation on one or more Clients 120.

### Multi-Stage Execution

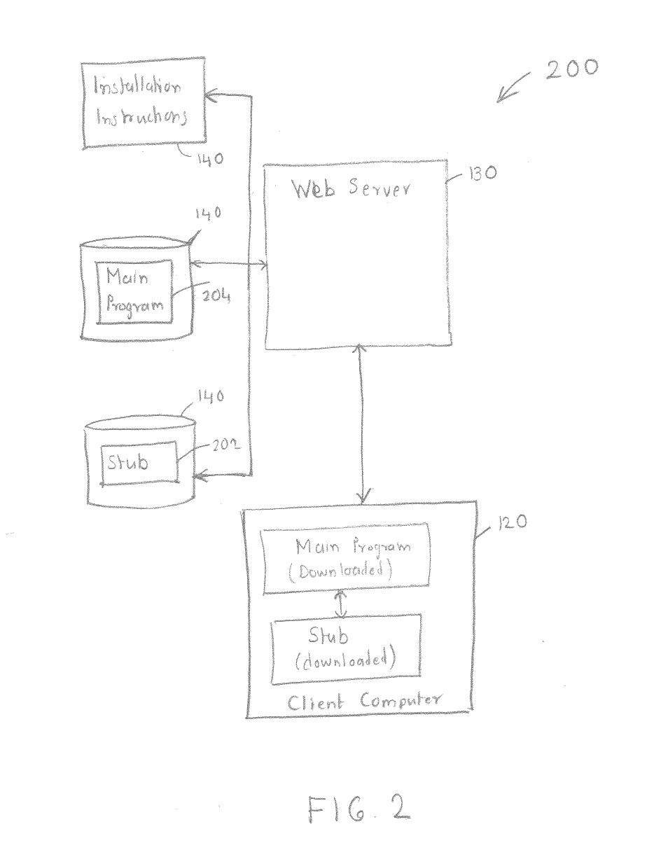

With reference to FIG. 2, a software installation system 200 includes several executable program files. First, a bootstrap component 202 (i.e., the stub) directs the download of another software component 204 (i.e., the main program) from a web service such as that provided by the Web Server 130 (shown in FIG. 1). The bootstrap component 202 then executes the other software component (i.e., the main program) 204, and may discard or cache the other software component.

The software installation system 200 may direct the user to a web site at which he can request and display a list of applications available from a web service which may be associated with the web site. The user may select a set of software applications on the web page and confirm the selection by, for example, clicking on a button, or responding to a email or text message. The user's web browser may then initiate an HTTP POST request to transmit the list of selected applications to the web service. The web service may respond by sending the first program component (i.e., the bootstrapping component or the stub) 202. The web service may add a unique sequence of bytes, herein referred to as the “key,” to the stub in a process called “tagging.” The user then executes the stub program 202 on his client device, such as the Client 120.

During execution, the stub program 202 may contact the web service and request information about the next program stage. This information typically includes a Uniform Resource Locator (URL) directing the installation process to the location of the next program component. The stub 202 then downloads the next program stage (i.e., the main program) 204 from that URL. Thus, the user may be assured that the most up to date version of the main program is downloaded from the web service (e.g., via the web server 130 of FIG. 1). In one embodiment, the stub 202 verifies the authenticity of the main program 204 using public key cryptography. The stub then executes the main program, passing along the key to the main program 204 as well as any command line parameters that were passed to the stub 202.

The main program 204 contacts the web service transmitting the key to the service. The web service responds with the installation information for the applications associated with the key, and that information is then processed by the main program. The stub program 202 waits for the end of execution of the main program and then discards the main program executable image.

### Processing of Installation Instructions by the Main Program

In some embodiments, the installation instructions contain specific instructions for installing each selected software application. For each application, there is at least one “configuration” which encapsulates the information needed to install that application under certain circumstances. The configuration may include a list of files needed for the installation, instructions for retrieving those files, e.g., from the Internet, program instructions for performing the installation steps, lists of locales, system architectures and operating system versions with which the configuration is compatible, instructions for automating user interface interaction with setup programs, instructions for determining the currently installed version of this application, instructions for verifying if an installation was successfully performed, instructions for checking if a version of the software application to be installed is currently running, a list of shortcuts that are normally created during the installation of the application, and any combination of these attributes.

For each application, a matching algorithm in the main program determines the most suitable configuration for the operating environment associated with the user's computer. This determination may be based on a number of factors, including but not limited to the operating system version, the operating system language, the machine processor architecture, the presence of Service Packs (major operating system updates on Microsoft Windows, for example), and any current command line parameters.

### Matching Algorithm

In some embodiments, the matching algorithm performs the following steps. The list of configurations is filtered to exclude any configurations that are not compatible with the current operating environment, considering various factors including operating system version and machine architecture. Each configuration may contain a custom program that determines if the configuration is compatible with the current environment. Such a program takes as its input information about the current system, including the operating system version, language, and command line parameters passed to the main program 204. The custom program also collects information from the local file system and registry. Based on this information, the program returns a value indicating if the configuration is compatible with the current environment, and the custom program can optionally return a value indicating the reason for incompatibility. An exemplary custom program can search the local hard drive for incompatible third party programs and mark the configuration incompatible if any such conflicting third party programs are found.

The matching algorithm then searches the remaining configurations to find the first one that matches the operating system's “locale,” e.g., the language and country settings of the operating system. If there are no matches, the matching algorithm may search for the first configuration that matches a set of default parameters, e.g., English and the United States as the language and country, respectively. If there are no matches, the algorithm searches for the first configuration that matches English as the language. If no matching configuration is still found, the result is empty and the installation may terminate unsuccessfully. If a match is found, the matching algorithm returns the matched configuration and the matched language identifier and, optionally, the matched country identifier. The matched configuration is used during subsequent steps such as installation and audit.

### Downloading Files for Installation

The matched configuration data may, in some instances, contain a list of files needed for installing the application. For each file, an expression that evaluates to a URL is analyzed by the main program 204 to compute the URL, based on various factors which include, but are not limited to, the matched language and the matched country. After the main program 204 computes the URLs based on the expressions, the main program 204 downloads the files identified by the one or more computed URLs.

### Complex URL Expressions

In some embodiments, the URL expression may itself be a program for downloading resources. The URL expression may contain additional instructions to retrieve data from other URLs. A result computed by the URL expression may be based on the computation of these data from the other URLs. For example, a URL expression (i.e., the download program) may fetch an html page from a vendor's web server. The html page may contain a link to an installer file supplied by the vendor. The download program then extracts the relevant link from the html page and in turn downloads the installer file. This mechanism can be useful if the URL to the download page (i.e., the html page) is relatively stable but the download links to the actual target resource change frequently.

More complex interactions with web servers may be necessary to download certain resources, including receiving and sending cookies and sending referrers (e.g., HTTP referrer header). A URL expression that is a download program can interact with web servers in complex ways with the goal of downloading a particular required resource. The URL expression language generally contains primitives to send HTTP requests and to manipulate the result. The request may contain attributes including, but not limited to, the target URL, HTTP Cookies and HTTP Referrer. The result may contain the response data, HTTP Cookies, the HTTP Status Code and other parts of the HTTP response.

### Installation Scripting Language

In some embodiments, each configuration includes an installation script for installing the software application. Instructions include, but are not limited to the creation of processes, reading and writing of files, and reading and writing of registry values.

### Version Checking

Each configuration may also include instructions for determining the version (if any) of the software application that is currently installed on the user's computer. In one embodiment, these instructions are supplied in the form of expressions in a purpose-built programming language. For example, to determine the version of a given software application, it may be necessary to look up the file location of the software application in the registry, and then to read the file attributes of a file at that location. These steps can be quite tedious to be expressed in common programming languages. A custom-built language may provide functional primitives to make the construction of version-checking programs relatively easy compared to manual or other automated methods of version checking.

An exemplary expression in the custom language that can perform the above steps is “fileversion(registry(“hklm\software\myapp\installlocation”)+“\myapp.exe”).” This expression reads a file path string of a third party application “myapp” from the registry using the “registry” function, constructs a file path, and then reads the file version information from the executable file at that location.

Another complex example requires searching for registry keys and files using patterns. The expression “fileversion(registry(“hklm\software\myapp*\installlocation”)+“\myapp*.exe”)” searches the registry for values that match one or more patterns passed to the “registry” function. For each value obtained from the registry function, the expression creates a file path that is used to search for files matching the pattern. For each matching file name, the file version is extracted. The overall version value of the expression is the largest version number of the resulting set of versions. Such complex searches are frequently needed when searching for the installed versions of programs. Without a domain specific, custom language these searches tend to be tedious to implement. The custom language provides primitives to access and manipulate data including, but not limited to the version information attached to files, registry values, and directory contents.

Version checking may be performed by the main program 204 before the installation. If the version check determines that the software application to be installed is already installed and the version number equals (or is greater than) the application version about to be installed, the main program 204 may skip the installation of that software application, or alternatively message the user and request further instructions.

### Audit

The installation system 200 may also operate in “audit mode” to determine the version numbers of applications installed on a computer. Audit mode skips the actual installation of applications and instead compiles a report of the versions of the installed software applications as determined by the version checking mechanism described above. The report may be presented to the user, to providers of the application(s) being installed for quality assurance or license tracking purposes, and/or IT staff to ensure security compliance, among others.

### Offline Installers

The multi-stage installation/execution system 200 typically requires an active Internet or cellular connection to allow the system to download various data, including the main program, program installation instructions, and program installation files. In some instances, the installation system 200 may operate in “freezing” mode. The freezing process creates a version of the installation system called an “offline installer” that can function on computers without Internet or cellular access.

An offline installer operates as a single executable file that contains the data to function without access to a network (e.g., the Internet). The freezing process creates the offline installer by instructing the main program 204 to traverse the list of software applications to be installed while still connected to the network. These applications are retrieved from the web service by sending the key embedded in the calling stub.202. For each application, the main program 204 traverses one or more configurations associated with that application. For each relevant configuration, the program evaluates the URL expressions. For each URL, the main program 204 downloads the corresponding file to a temporary location. Once all files have been successfully collected, the main program 204 creates a copy of itself. The main program 204 then embeds the installation instructions and the downloaded files in the copy.

In general, when run, the main program 204 checks for any embedded installation instructions. This way the main program 204 can determine if it is being run as part of an offline installer or if it is being run in the “online” manner (in which the main program 204 was downloaded by the stub and that the main program should fetch the installation instructions from the server). In other words, the main program 204 normally fetches the installation instructions from the server, but if the offline mode is detected (by the existence of embedded installation instructions) the main program 204 uses those instructions and the embedded files to perform the software application installation tasks, instead of contacting the web server.

### Silent Installation

The end user may instruct the stub 202 and the main program 204 not to show any user interface (UI) components when run. This option may be exposed as a command line switch.

### Caching

In one embodiment, the system 200 saves (i.e., caches) the downloaded data into files on the disk, and under certain circumstances, uses these stored data instead of downloading the data/files from the Internet again. The stored data may be referenced by a strong hash value of the data to be stored. SHA-1 is an exemplary hash algorithm used for hashing. When storing the data, the program calculates the strong hash value of the data and then stores the data in a file, naming the file with a string representation of the hash value. As part of the caching mechanism, the configuration data may also contain the hash values of the files listed within the configuration. When the installation system 200 needs to download a file, the system 200 may first determine if the cache directory contains a file with the correct hash. If such a file is located, the download step may be skipped and the data may instead be read from the cached file.

### Controlled Execution of Processes

One important part of installing software applications is the automated and controlled execution of third-party setup programs, which is generally required while installing third-party software applications. Some embodiments use, but are not limited to, the following techniques for executing third party setup programs in an automated and controlled manner: controlling child processes, hiding unwanted user interface elements, UI automation, UI automation feedback loops, detection of pre-installation error conditions, unified interfaces to application configuration, load selection, and combinations thereof.

### Controlling Child Processes

In some instances, when the main program 204 runs a setup program, it attaches the processes created to run the setup program to a “Job Object” (a Microsoft Windows-specific operating system mechanism). The Job Object is monitored to detect the presence of any child processes of the setup program. Based on the instructions in the configuration data, the main program 204 may wait for any child processes to terminate. The third party setup program may create child processes to perform the installation of the subordinate programs and the setup program may then immediate terminate. In this case, the main program 204 waits for the child processes of the third-party setup program to finish the installation, before undertaking other steps of installation. Alternatively, the main program 204 may terminate any remaining child processes once the setup program terminates. This can be beneficial if the third party setup program launches the installed application once the installation is finished, but the user only wishes to install software applications and does not wish to launch the installed application immediately after the installation.

### Hiding Unwanted User Interface Elements

In some embodiments, the system 200 may hide the third-party setup UIs during installation. To this end, the main program 204 runs the third-party setup programs/processes on a separate “Desktop” (a Microsoft Windows-specific operating system mechanism). This effectively hides user interface elements from the visible default desktop. To run the setup process on a separate Desktop, the CreateDesktopW API is used to create a new Desktop object with a unique name. The CreateProcessW API is used to create the setup process with the lpDesktop member of the STARTUPINFOW structure set to the name of the new Desktop.

### UI Automation

The main program 204 can monitor the execution of the setup programs. In particular, the main program 204 can periodically scan the UI elements associated with the setup program process and child processes thereof. This result is a hierarchical representation of the windows and UI controls of the setup program at that point of execution, referred to as the “UI state,” This representation is matched against a list of rules, referred to as the “UI script.” Each rule in the UI script has an action associated with that rule. The first rule that matches the present UI state during execution of the setup program is selected and the associated action is performed. Actions include sending of messages to the setup process to simulate a mouse click, closing a window, terminating a process, simulating the pressing of a key and setting the content of an edit control. As such, user interaction is emulated, and optionally, the display of the UI and the automatic response provided by the main program 204 are hidden, as described above, so as to install applications automatically and seamlessly, without any or substantial user input.

The main program 204 facilitates the assembly of the UI state. To do so, the main program 204 retrieves the list of processes associated with the Job Object (described above) using the QueryInformationJobObject API. For each process, the main program 204 assembles the list of all top-level windows associated with the process by enumerating all top-level windows with the EnumWindows API and filtering the result to exclude any windows that do not belong to the process using the GetWindowThreadProcessId API. For each top-level window, the main program 204 assembles a list of child windows, thus representing the UI state, using the EnumChildWindows API. For each window, additional attributes may be added to the UI state, including but not limited to attributes retrieved by the GetClassName and GetWindowText APIs. In some embodiments, the main program 204 may assemble the UI state using the Microsoft Active Accessibility API or the Microsoft UI Automation API.

The UI state can be a complete representation of the UI elements associated with the setup program at a certain point during its execution. The UI state includes the state of UI elements such as captions, text of edit controls, checked-state of checkboxes, etc. Thus, the UI state can be a tree-shaped snapshot of the windows and controls of the third party setup processes at a given point of time. The rules in the UI script are then matched against this tree, and if a rule matches, the associated action is performed. For example, the rule/action can be (stated herein in natural language): if there is a control with the caption “Proceed” and if there is a button with the caption “OK,” then simulate a mouse click on that button. Another example may be if there is a checkbox labeled “Install component A” and if the checkbox is not checked, then simulate a mouse click such that the checkbox is checked.

Thus, in general the UI automation engine within the main program 204 periodically creates a tree snapshot (e.g., once every second), then matches the rules against the snapshot, and if a rule matches, performs the action associated with the matched rule. Accordingly, the actions specified by the rules can be triggered dynamically based on simulated user input, and the state tree may also change in response to the simulated user input.

### UI Automation Feedback Loop

In some embodiments, the main program 204 monitors setup programs for error conditions. One exemplary error condition is the presence of a UI state for which no automation rule exists. If such an error condition is detected, the main program 204 aborts the installation and sends the UI state to a web service. A human operator may view the UI state that caused the error condition and create a new UI automation rule for this particular state. This feedback loop allows for the future automation of the UI state that resulted in the rare error condition, and avoidance of that error.

### Detection of Pre-Installation Error Conditions

In some embodiments, while installing a software application on a computer on which a version of that application is already installed (a common occurrence during software updates), certain common error conditions are encountered on computers running the Microsoft Windows operating system. In particular, if the software application to be installed/updated is running during the installation (i.e., a process exists which has loaded an executable image belonging to the software application to be installed/updated), the setup program often fails to replace the existing executable files with the new versions because the loaded executable files are locked by the operating system. In order to avoid failed installations, the main program 204 may detect this error condition before performing the installation.

Another likely error condition is the presence of another installer process. If another installer process is already running, this commonly leads to failed installations. This condition can be detected in advance and the installation by the system 200 can be aborted. One method of detection of another installer processes is to check the existence and state of the “Global\_MSIExecute” mutex using the OpenMutex and WaitForSingleObject Windows API functions.

To detect if the software application to be installed is presently running or being installed/updated by another installer, the main program 204 may also use the CreateFile API to attempt to open files that exist on the computer and that are known to belong to the software application to be installed. The dwDesiredAccess parameter is set to a value that causes the API call to fail if the file is locked, and to succeed otherwise. A suitable value is the DELETE constant from the WinNT.h header file supplied by Microsoft.

### Unified Interfaces to Application Configuration

In some embodiments, the installation system 200 exposes configuration parameters for the software applications to be installed in a unified way. Specifically, a common function offered by several setup programs is the option to skip the creation of “Desktop shortcuts” and “QuickLaunch shortcuts” (e.g., on Microsoft Windows operating system). These shortcuts are normally created by the setup programs to allow users to launch the installed software application, but they may be undesirable to the users in some situations. In one embodiment, users may specify whether they would like to suppress these shortcuts using, for example, a command line switch called “Disable Shortcuts” option.

The main program 204 implements the Disable Shortcuts option by assembling a list of shortcuts that existed before installing any software application (called the before set), assembling a list of shortcuts that exist after the installation (called the after set), and by subtracting the before set from the after set to generate a change set (the set of shortcuts that were added during installation). The main program 204 then deletes these shortcuts if the user selected the Disable Shortcuts option. As such, the shortcuts are created during installation and are then deleted right after the installation.

The main program 204 can assemble the list of existing shortcuts as follows. For each relevant location, the FindFirstFile/FindNextFile combination of APIs is used to list files with the file extension of shortcuts (the string “.lnk”). Relevant locations may include desktop directories and QuickLaunch directories (e.g., on the Microsoft Windows operating system). The file system paths to these locations may be retrieved through APIs including SHGetFolderPathW and SHGetSpecialFolderPathW.

In one embodiment, as opposed to deleting all shortcuts in the change set, the change set is compared with a list of known patterns and only the shortcuts that match a known pattern are deleted. This prevents the unwanted deletion of shortcuts that were added during the installation by the user using another program and not by the setup programs. For example, the user may create a new shortcut named “My shortcut.lnk” on his/her desktop while an installation of the “MyApp” software application is in progress. The MyApp setup program may create a new shortcut on the desktop named “MyApp 1.2.lnk.” The resulting change set (i.e., the set of newly created shortcuts) after the installation is (“My shortcut.lnk;” “MyApp 1.2.lnk”). It would be undesirable to delete all shortcuts in the change set because then the user-created shortcut would also be deleted.

To prevent this, the installation instructions used by the main program 204 to install My App may contain a list of patterns of shortcuts which are expected to be created during the installation of My App. In this example, the list of patterns may only contain one entry: “MyApp *.lnk.” The change set is then compared with the patterns in the installation instructions, and entries that do not match any pattern (e.g., My shortcut.lnk) are discarded. Only the shortcuts in the resulting filtered set are deleted.

In one embodiment, the install script executed by the main program 204 passes specific command line parameters to the setup program of a software application to be installed with instructions to skip the creation of shortcuts, if the setup program of that software application exposes such functionality. If the setup program does not expose such functionality, the above described method of deleting shortcuts can be employed.

### Local Selection

Local selection allows a user to select a subset of software applications from the stub/bootstrap component 202 without visiting the website (e.g., at Server 130 of FIG. 1) when the stub 202 is run. In effect, the installation system 200 uses local selection to install different sets of applications without repeatedly using the web site to create tagged stubs for those sets of applications. To use this feature, the user may obtain an installer stub from the web site once. The user then selects any software applications to be installed/updated using local selection in the future.

As described above, the stub 202 contains a key which refers to a set of software applications and the stub 202 may be obtained from the website by selecting a set of applications and downloading the corresponding stub. When the local selection feature is used, the user typically downloads a stub that contains (via the key) all available software applications that may be installed/updated by the installation system 200. In one embodiment, when the user runs the stub 202, the instructions retrieved from the server (e.g., the Server 130) indicate that the main program 204 must display a selection window. The main program 204 shows a selection window (e.g., a graphical UI showing a list of all software applications available for installation/update) where the user can select which software applications from the larger set (represented by the keys in the stub 202) the user actually wants to install/update or to audit.

In other embodiments, a command line switch “/select” may be used to specify the subset of applications. The user specifies the switch along with a list of software application names. The main program 204 evaluates the list of application names and performs the required tasks for those applications. This way, the user does not have to frequently visit the website because he/she can select any available software applications the user wishes to install/update at that time from the selection window or via the “/select” command line switch. Thus, the local selection then allows the user to select a subset of applications from the installer stub 202 without visiting the website when the stub 202 is run.

### Remote Mode

The installation system 200 also allows users to perform installations remotely on other computers on the network. The instance of the installation system 200 running on the user's computer is referred to as the initiating instance. The user specifies the names of the target computers and login credentials to access the target computers. If no credentials are specified then the installation system users the credentials of the current user account. For each of the target computers, the installation system 200 performs the following steps. A copy of the one or more executable files of installation system 200 are created on the target computer using network file operations. The initiating instance of the installation system 200 then creates a service on the target computer (e.g., using the CreateService API on a computer having the Windows operating system). The service is set to execute the copied executable files of the installation system 200. The service is then started (e.g., using the StartService API), thereby creating a remote instance of the installation system 200 on the remote computer. The service then connects to the initiating computer using a communication mechanism, e.g., named pipes.

At this point a communication channel is established between the remote instance and the initiating instance. The remote instance performs installation and/or audit tasks. Any requests that would otherwise be sent to the Internet services are instead sent through the named pipe to the initiating instance. The initiating instance handles these requests on behalf of the remote instance and returns the requested data to the remote instance. The initiating instance may use multiple threads of execution to serve multiple remote instances at the same time. This way, it is possible to perform installations on several remote computers simultaneously.

Once a remote instance has finished its task, the remote instance sends a status report back to the initiating instance. Then, the service and executable on the remote computer are deleted. When all remote instances are finished, the initiating instance compiles a combined status report from all the status reports sent by the individual several remote instances.

Each functional component described above may be implemented as stand-alone software components or as a single functional module. In some embodiments the components may set aside portions of a computer's random access memory to provide control logic that affects the interception, scanning and presentation steps described above. In such an embodiment, the program or programs may be written in any one of a number of high-level languages, such as FORTRAN, PASCAL, C, C++, C#, Java, Tcl, PERL, or BASIC. Further, the program can be written in a script, macro, or functionality embedded in commercially available software, such as EXCEL or VISUAL BASIC.

Additionally, the software may be implemented in an assembly language directed to a microprocessor resident on a computer. For example, the software can be implemented in Intel 80×86 assembly language if it is configured to run on an IBM PC or PC clone. The software may be embedded on an article of manufacture including, but not limited to, computer-readable program means such as a floppy disk, a hard disk, an optical disk, a magnetic tape, a PROM, an EPROM, or CD-ROM.

The invention can be embodied in other specific forms without departing from the spirit or essential characteristics thereof. The foregoing embodiments are therefore to be considered in all respects illustrative rather than limiting on the invention described herein.

What is claimed is:

1. A method for automatically installing a software application component on a computer, the method comprising:
sending from a computer an identification of a first software application component to be installed on the computer;
receiving, at the computer:
a bootstrap component comprising a key corresponding to the first software application;
at the direction of the bootstrap component, a main program;
software installation instructions for installing the software application component on the computer; and
at the direction of the main program operating based on the software installation instructions, the first software application component, and
identifying, at the computer by the main program a version of the first software application component, if the first software application component is installed on the computer; and
installing on the computer, at the direction of the main program operating based on the software installation instructions and the identified version, the first software application component.

2. The method of claim 1, wherein the software installation instructions comprise a Uniform Resource Locator (URL).

3. The method of claim 2, wherein the URL is a URL expression comprising instructions to retrieve data from other URLs.

4. The method of claim 3, wherein the URL expression comprises primitives to send HTTP requests and manipulate a response.

5. The method of claim 1, further comprising, executing instructions including primitives to access and manipulate data of the version of the software application component installed on the computer.

6. The method of claim 1, further comprising:
traversing each of a plurality of programs to be installed using the main program; and
for each traversed program,
retrieving configuration information;
retrieving URL expression from the configuration information; and
retrieving a program corresponding to the URL expression; and
storing the program in temporary file.

7. The method of claim 6, further comprising:
creating a copy of the main program; and
embedding offline installation instructions and the temporary file in the copy of the main program.

8. The method of claim 1, wherein the installation instructions comprise a plurality of configurations for the application component.

9. The method of claim 8, further comprising selecting one of the plurality of configurations based on an algorithm executed by the main program.

10. The method of claim 9, wherein the algorithm selects the one of the plurality of configurations based on one or more of operating system version, operating system language, machine processor architecture, service pacts, and command line parameters.

11. The method of claim 1, further comprising creating a tree representation of user interface elements.

12. The method of claim 11, further comprising identifying erroneous user interface states by matching user interface states associated with the first software application component with the tree representation of user interface elements.

13. The method of claim 12, further comprising sending identified erroneous user interface states to a server for inspection.

14. A method for providing installation software to a computer, the method comprising:
receiving at a computer server an identification of a first software application component to be installed on a client computer;
sending, by the computer server:
a bootstrap component comprising a key corresponding to the first software application component;
a main program configured to identify a version of the first software application component, if the first software application component is installed on the client computer;
software installation instructions for installing the software application component on the client computer; and
the first software application component.

15. A system for installing software on a computer, the system comprising:
one or more client computers; and
one or more computer servers, the computer servers configured to perform the operations of:
receiving an identification of a first software application component to be installed on the one or more client computers; and
sending:
a bootstrap component comprising a key corresponding to the first software application;
a main program configured to identify a version of the first software application component, if the first software application component is installed on the one or more client computers;
software installation instructions for installing the software application component on the one or more client computers; and
the first software application component.
